(19) United States
(12) Patent Application Publication
(10) Pub. No.: US 2022/0301335 A1
(43) Pub. Date: Sep. 22, 2022

(54) DATA LOCATION MAPPING AND EXTRACTION

(71) Applicant: DADO, Inc., Oakland, CA (US)

(72) Inventors: JAKE OLSEN, Alameda, CA (US); GREG SANTORO, San Francisco, CA (US); RYAN GRIMM, Pacifica, CA (US); GENE CONROY-JONES, Seattle, WA (US)

(73) Assignee: DADO, Inc., Oakland, CA (US)

(21) Appl. No.: 17/696,820

(22) Filed: Mar. 16, 2022

Related U.S. Application Data
(60) Provisional application No. 63/161,950, filed on Mar. 16, 2021.

(51) Int. Cl. G06V 30/422; G06F 3/0482; G06V 30/414; G06F 16/93

(52) U.S. Cl. CPC G06V 30/422; G06F 3/0482; G06V 30/414; G06F 16/93

(57) ABSTRACT

Apparatuses, systems, methods, and computer program products are disclosed for data location mapping and extraction. A method displays a graphical user interface to a user on an electronic display screen for a computing device. A graphical user interface comprises user interface elements allowing the user to identify a plurality of locations within a first document. A method includes receiving user input based on the user interacting with the user interface elements of the graphical user interface to identify the plurality of locations within the first document. A method includes detecting a subsequent document. A method includes extracting data from the subsequent document based on the plurality of locations identified within the first document.

### CROSS-REFERENCES TO RELATED APPLICATIONS

This claims the benefit of U.S. Provisional Patent Application No. 63/161,950 entitled “DATA LOCATION MAPPING AND EXTRACTION” and filed on Mar. 16, 2021, for Ryan Grimm, et al., which is incorporated herein by reference in its entirety for all purposes.

### FIELD

The subject matter disclosed herein relates to document management systems and more particularly relates to automated data location mapping and extraction for documents.

### BACKGROUND

Many industries, such as the construction industry, make use of documents that may be at least partially repetitive, with similar data in multiple documents. Manually transcribing and/or extracting similar data from different documents can be time consuming and can introduce errors in the data.

### SUMMARY

Computer program products are disclosed for data location mapping and extraction. A computer program product, in some embodiments, comprises program code stored on a non-transitory computer readable storage medium. Program code, in one embodiment, is executable by a processor to perform operations. In certain embodiments, an operation includes displaying a graphical user interface to a user on an electronic display screen for a computing device. A graphical user interface, in some embodiments, comprises user interface elements allowing the user to identify a plurality of locations within a first document. An operation, in a further embodiment, includes receiving user input based on the user interacting with the user interface elements of the graphical user interface to identify the plurality of locations within the first document. In one embodiment, an operation includes detecting a subsequent document. An operation, in certain embodiments, includes extracting data from the subsequent document based on the plurality of locations identified within the first document.

Methods are disclosed for data location mapping and extraction. In certain embodiments, a method includes displaying a graphical user interface to a user on an electronic display screen for a computing device. A graphical user interface, in some embodiments, comprises user interface elements allowing the user to identify a plurality of locations within a first document. A method, in a further embodiment, includes receiving user input based on the user interacting with the user interface elements of the graphical user interface to identify the plurality of locations within the first document. In one embodiment, a method includes detecting a subsequent document. A method, in certain embodiments, includes extracting data from the subsequent document based on the plurality of locations identified within the first document.

Apparatuses are disclosed for data location mapping and extraction. In certain embodiments, an apparatus includes means for displaying a graphical user interface to a user on an electronic display screen for a computing device. A graphical user interface, in some embodiments, comprises user interface elements allowing the user to identify a plurality of locations within a first document. An apparatus, in a further embodiment, includes means for receiving user input based on the user interacting with the user interface elements of the graphical user interface to identify the plurality of locations within the first document. In one embodiment, an apparatus includes means for detecting a subsequent document. An apparatus, in certain embodiments, includes means for extracting data from the subsequent document based on the plurality of locations identified within the first document.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for data location mapping and extraction;

FIG. 2 is a schematic block diagram illustrating one embodiment of a graphical user interface;

FIG. 3 is a schematic block diagram illustrating a certain embodiment of a graphical user interface;

FIG. 4 is a schematic block diagram illustrating a further embodiment of a graphical user interface;

FIG. 5 is a schematic block diagram illustrating another embodiment of a graphical user interface;

FIG. 6 is a schematic block diagram illustrating a certain embodiment of a graphical user interface;

FIG. 7 is a schematic block diagram illustrating a further embodiment of a graphical user interface;

FIG. 8 is a schematic flow chart diagram illustrating one embodiment of a method for data location mapping and extraction; and

FIG. 9 is a schematic flow chart diagram illustrating a further embodiment of a method for data location mapping and extraction.

### DETAILED DESCRIPTION

As will be appreciated by one skilled in the art, aspects of the embodiments may be embodied as an apparatus, system, method, or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

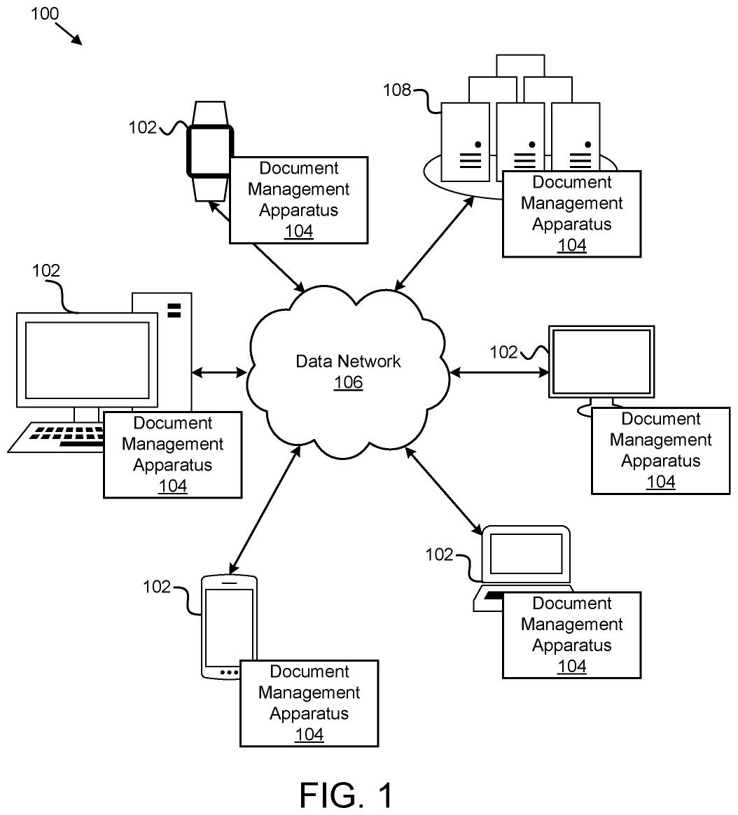

FIG. 1 depicts one embodiment of a system 100 for data location mapping and extraction. In one embodiment, the system 100 includes one or more computing devices 102, one or more document management apparatuses 104, one or more data networks 106, and one or more servers 108. In certain embodiments, even though a specific number of computing devices 102, document management apparatuses 104, data networks 106, and/or servers 108 are depicted in FIG. 1, one of skill in the art will recognize, in light of this disclosure, that any number of computing devices 102, document management apparatuses 104, data networks 106, and/or servers 108 may be included in the system 100.

In general, in certain embodiments, the document management apparatus 104 is configured to provide a graphical user interface (GUI) to a user (e.g., on an electronic display screen for a hardware computing device 102, or the like), enabling the user to identify locations (e.g., one or more data elements, key information, relevant information, predefined information, or the like) in one or more documents. An identified location and/or data element, in one embodiment, may be important and/or otherwise relevant for classifying and/or identifying the document (e.g., a type of document, a class of document, a category of document, or the like). The document management apparatus 104 may allow a user, within the GUI, to identify one or more locations (e.g., an X-Y coordinate, a relative location, a field identifier, one or more offsets, or the like) of one or more data elements within the document, where the identified one or more data elements are disposed within the document, and to save the identified one or more locations (e.g., as a template, in a template library, or the like). Different templates, with different identified locations, may be associated with different types of documents, different categories of documents, different classes of documents, or the like (e.g., schematic documents, blueprints, construction documents, architectural documents, permits, licenses, legal documents, medical documents, contracts or other agreements, receipts, invoices, tax documents, maintenance documents, warranty documents, insurance documents, letters, emails, text messages, journals, photographs, books, magazines, newspapers, envelopes, statements, certificates, records, and/or other types of documents).

For example, in certain embodiments, the document management apparatus 104 may display a graphical representation of a data element to be identified within the GUI (e.g., overlayed on top of the document, disposed adjacent to the document, or the like), and receive user input from a user moving (e.g., dragging and dropping, swiping, touching, selecting, or the like) the graphical representation of the data element to a location within the document (e.g., thereby identifying the location and associating the location with the data element represented by the graphical representation).

The document management apparatus 104, in some embodiments, may allow a user to apply one or more saved locations for identified data elements defined for a first document (e.g., saved as a template, saved to a template library, or the like) to one or more different documents (e.g., subsequent documents, detected documents, or the like). The document management apparatus 104 may automatically process the one or more subsequent documents (e.g., in a batch, detected documents, scanned documents, or the like) to extract the identified data elements from the one or more subsequent documents based on the one or more identified and/or saved locations. The document management apparatus 104 may store the extracted data elements (e.g., in a database, file, and/or another data structure stored on a non-transitory computer readable storage medium, stored on a hardware server device 108, or the like), display the extracted data elements in a GUI (e.g., on an electronic display screen of a hardware computing device 102), or the like.

In one embodiment, the document management apparatus 104 may share a template library of multiple saved templates between different users and/or hardware computing devices 102, from a hardware server 108, over a data network 106, or the like. A template library of multiple saved templates, in some embodiments, may be selected, built, shared, and/or curated by one or more users (e.g., with sharing permissioned by a creating user, an owning user, an administrator, or the like using a GUI of the document management apparatus 104).

For example, in some embodiments, one user may photograph and/or scan a document from one hardware computing device 102 (e.g., using a camera, a scanner, or the like coupled to the hardware computing device 102), the document management apparatus 104 (e.g., locally on the hardware computing device 102, remotely on the backend server 108, or the like) may display a GUI allowing the user to identify one or more locations within the document, the document management apparatus 104 may upload a template comprising the identified locations and/or the document to the server 108 over the data network 106, and other users on different computing devices 102 may access the template from the backend server 108 over the data network 106 for use with subsequent documents. In a further embodiment, a document management apparatus 104 may provide a local template library on a single hardware computing device 102 (e.g., instead of or in addition to providing a template library over a data network 106).

The document management apparatus 104, in certain embodiments, may use a matching algorithm to select a matching template from a template library (e.g., a best matching template, a template with a highest likelihood of matching, or the like), in response to detecting a new document, an unmatched document, or the like. For example, the document management apparatus 104 may use a probabilistic analysis of data extracted from locations in a document based on multiple different templates in order to select a template to match with the document. The probabilistic analysis may be based on one or more rules defined based on the different templates (e.g., expected data types at certain locations, such as a date, a string of text, a number, a monetary amount, an image, a known label or other identifier, a filename, a predefined override code, and/or one or more other predefined or expected data types) and may match the document to a template based on the probabilistic analysis.

In some embodiments, the document management apparatus 104 may use machine learning or other artificial intelligence to automatically match a document to a template from a template library comprising a plurality of templates. The document management apparatus 104, in one embodiment, may learn and/or improve over time, processing and/or analyzing additional documents, extracted data elements, user input (e.g., user location identifications, manual user document/template matches, or the like), or the like and associating them or their metadata with templates in the template library to improve the accuracy of matching of subsequent documents to templates.

In order to extract data from a location (e.g., for a scanned or photographed document in which text is not stored in a computer readable format, or the like), in certain embodiments, the document management apparatus 104 may use optical character recognition (OCR) to approximate the text using machine learning and/or other artificial intelligence. In some embodiments, text in a document may have multiple directions and/or orientations. For example, in construction and/or architectural documents, text or symbols at some locations in the document may be rotated and/or have another different orientation than other text in the document. The document management apparatus 104, in some embodiments, may divide a document into smaller subsections, and may determine an orientation of and process each subsection independently, attempting to OCR different subsections in different directions/orientations until known words and/or other text are recognized, are legible, or the like. The document management apparatus 104 may determine a score for recognized text and/or symbols in each subsection in each orientation, and select the orientation with the best score for each subsection (e.g., for recognizing text, extracting data, or the like).

A document management apparatus 104 may provide one or more user interface elements for a user to add and/or define one or more rules to override or otherwise define a template match for a document. For example, a user may include a predefined override code (e.g., a known key, indicator, title, image, code, and/or other visual representation) in one or more documents and may associated the predefined override code with a template, and the document management apparatus 104 may automatically associate a document with the template in response to detecting the predefined override code (e.g., even if the document management apparatus 104 would otherwise match the document with a different template, or the like).

The document management apparatus 104, in some embodiments, presents a GUI to a user (e.g., on an electronic display screen of a hardware computing device 102, or the like) comprising a list of additional documents that have not yet matched a template from the template library. The document management apparatus 104 may display one or more extracted data elements from the unmatched additional documents, allowing a user to manually apply a template (e.g., from a template library), define a new template, or the like for one or more of the additional documents based on the extracted data elements. In a further embodiment, the document management apparatus 104 may display a list of matched documents, to which a template has been applied, and may allow a user to override and/or change the applied template to apply a different template.

The document management apparatus 104, in some embodiments, may provide a GUI allowing a user to define one or more rules for data extracted from identified locations of a document based on a template. For example, a user may define a rule specifying that, when multiple dates are extracted, a most recent date is to be used, an oldest date is to be used, or the like, may define a rule specifying that certain punctuation should be skipped/ignored, or the like.

In one embodiment, the system 100 includes one or more computing devices 102. The computing devices 102 may be embodied as one or more of a desktop computer, a laptop computer, a mobile computing device (e.g., a tablet computer, a smart phone, a personal digital assistant, a portable music player, a smart watch, a wearable fitness tracker, a smart speaker, or the like), a set-top box, a gaming console, a smart TV, an optical head-mounted display (e.g., a virtual reality headset, smart glasses, smart headphones, or the like), a High-Definition Multimedia Interface (“HDMI”) or other electronic display dongle, and/or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, an electronic display, a connection to an electronic display, or the like.

In certain embodiments, the document management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a head mounted display, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the document management apparatus 104 may include a power interface, a wired and/or wireless network interface, a graphical interface that attaches to a display, and/or a semiconductor integrated circuit device as described below, configured to perform the functions described herein with regard to the document management apparatus 104.

The document management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the document management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the document management apparatus 104.

The semiconductor integrated circuit device or other hardware appliance of the document management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the document management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), or the like.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more computing devices 102 and/or other servers, data centers, and/or the like. A server 108 may be a third-party server at a company, as part of a company's information system, e.g., as part of a company's human resource information system, and/or the like.

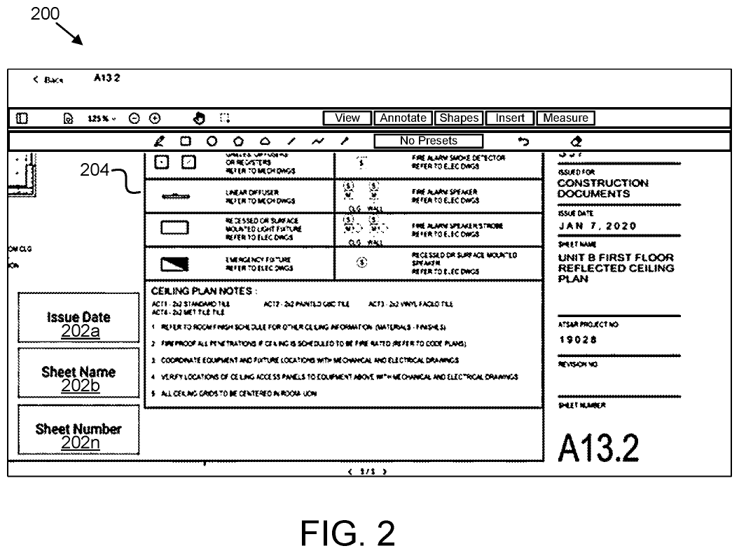

FIG. 2 depicts one embodiment of a graphical user interface 200 comprising one or more user interface elements 202a-n. A document management apparatus 104, in some embodiments, may display a graphical user interface 200 on an electronic display screen of a hardware computing device 102, or the like.

The graphical user interface 200, in the depicted embodiment, includes a display of an electronic document 204, which a user may have scanned, photographed, uploaded, saved, opened, and/or otherwise provided to the document management apparatus 104. The document management apparatus 104, in the depicted embodiment, displays one or more user interface elements 202a-n (e.g., adjacent to, overlayed above, and/or in another location relative to the document 204) in the graphical user interface 200, with which the user may interact, allowing the user to identify a plurality of locations within the electronic document 204 (e.g., locations of data elements, data fields, or the like). For example, in some embodiments, a user may drag and drop the user interface elements 202a-n onto and/or near the locations of the targeted data elements, data fields, or the like within the electronic document 204 (e.g., in the depicted embodiment, an issue date 202a, a sheet name 202b, and/or a sheet number 202n).

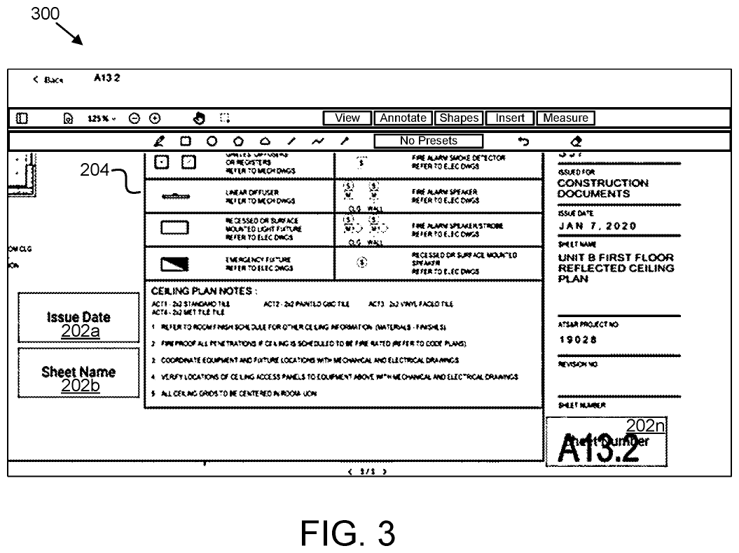

FIG. 3 depicts one embodiment of a graphical user interface 300. In the depicted graphical user interface 300, the user has interacted with a user interface element 202n to identify a location of data within an electronic document 204 (e.g., a sheet number 202n, or the like).

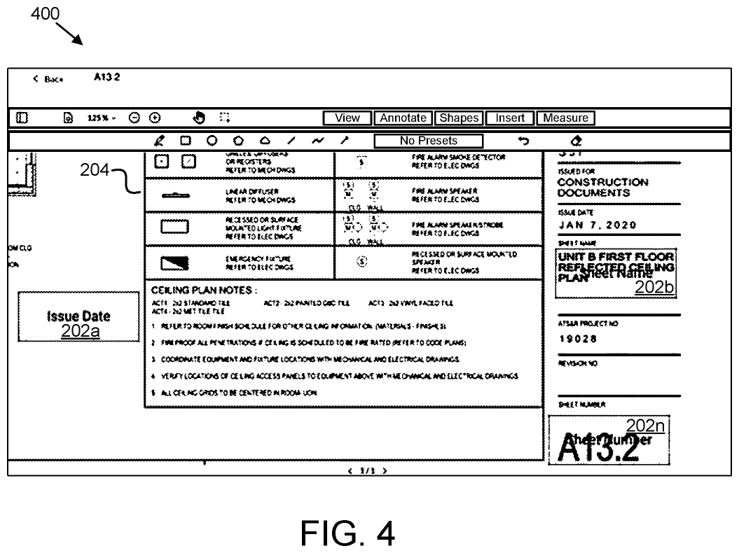

FIG. 4 depicts one embodiment of a graphical user interface 400. In the depicted graphical user interface 400, the user has interacted with a user interface element 202b to identify a location of data within an electronic document 204 (e.g., a sheet name 202b, or the like).

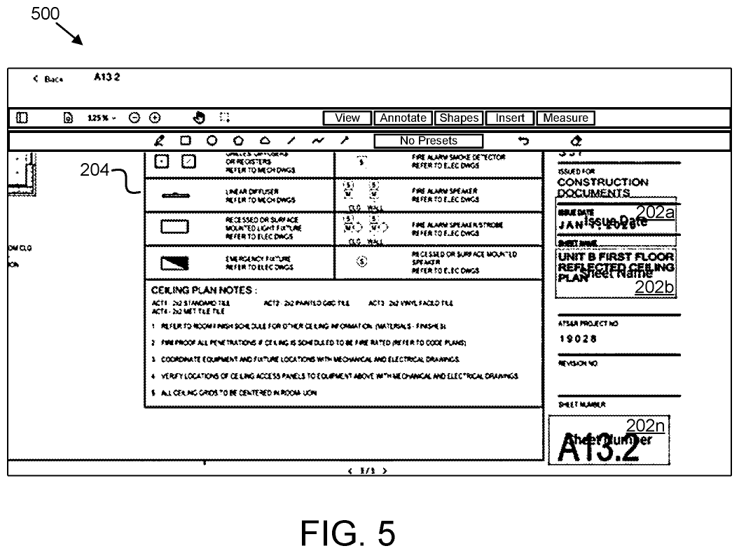

FIG. 5 depicts one embodiment of a graphical user interface 500. In the depicted graphical user interface 500, the user has interacted with a user interface element 202a to identify a location of data within an electronic document 204 (e.g., an issue date 202a, or the like).

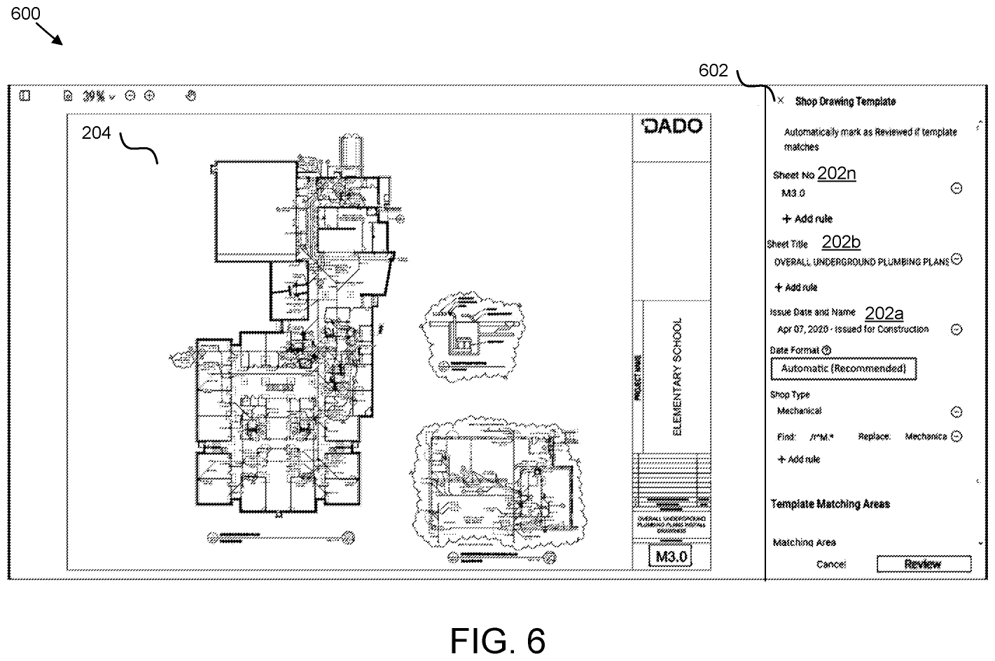

FIG. 6 depicts one embodiment of a graphical user interface 600. The graphical user interface 600 includes one or more document settings 602 for extraction of data from the electronic document 204 using a template. The document settings 602 allow a user to view extracted data for data elements 202a-n from identified locations, to remove extracted data, to add or remove rules associated with data elements 202a-n, to define a date format (e.g., automatic, manual, or the like), to adjust and/or override an identified location, to switch applied templates, or the like. The document settings 602 are displayed adjacent to a depiction of the electronic document 204, in the depicted embodiments.

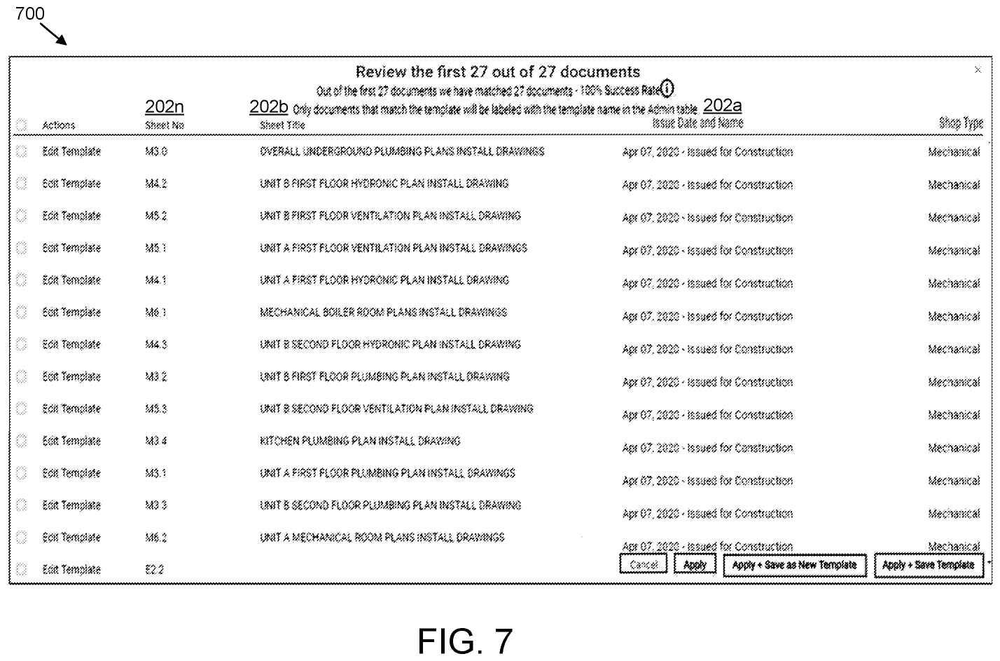

FIG. 7 depicts one embodiment of a graphical user interface 700. The graphical user interface 700, in the depicted embodiment, comprises a list of processed documents. In some embodiments, the list includes both documents that have matched templates from the template library, and documents that have not matched templates from the template library (e.g., may be filtered to show matched documents, unmatched documents, and/or both).

The graphical user interface 700, in the depicted embodiment, allows a user to manually apply a template, edit an applied template, apply edits, define and/or save a new template, save changes to an edited template, or the like. The graphical user interface 700, in some embodiments, displays one or more extracted data elements 202a-n from the processed documents (e.g., to assist the user in assessing an accuracy of a match with a template, to assist the user in selecting a template, to assist the user in editing a template, or the like).

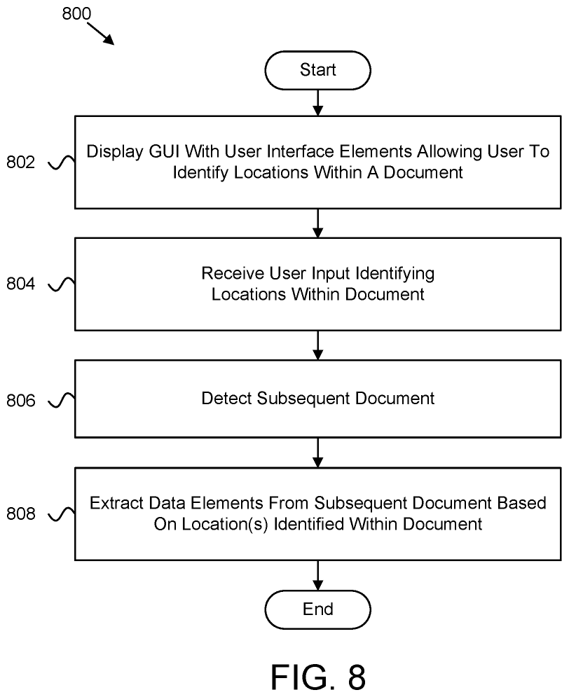

FIG. 8 depicts one embodiment of a method 800 for data location mapping and/or extraction. The method 800 begins, and the document management apparatus 104 displays 802 a graphical user interface 200, 300, 400, 500, 600, 700 to a user on an electronic display screen for a computing device 102, the graphical user interface 200, 300, 400, 500, 600, 700 comprising user interface elements 202a-n allowing the user to identify a plurality of locations within a first document 204.

The document management apparatus 104 receives 804 user input based on the user interacting with the user interface elements 202a-n of the graphical user interface 200, 300, 400, 500, 600, 700 to identify the plurality of locations within the first document 204. The document management apparatus 104 detects 806 a subsequent document 204. The document management apparatus 104 extracts 808 data from the subsequent document 204 based on the plurality of locations identified within the first document 204 and the method 800 ends.

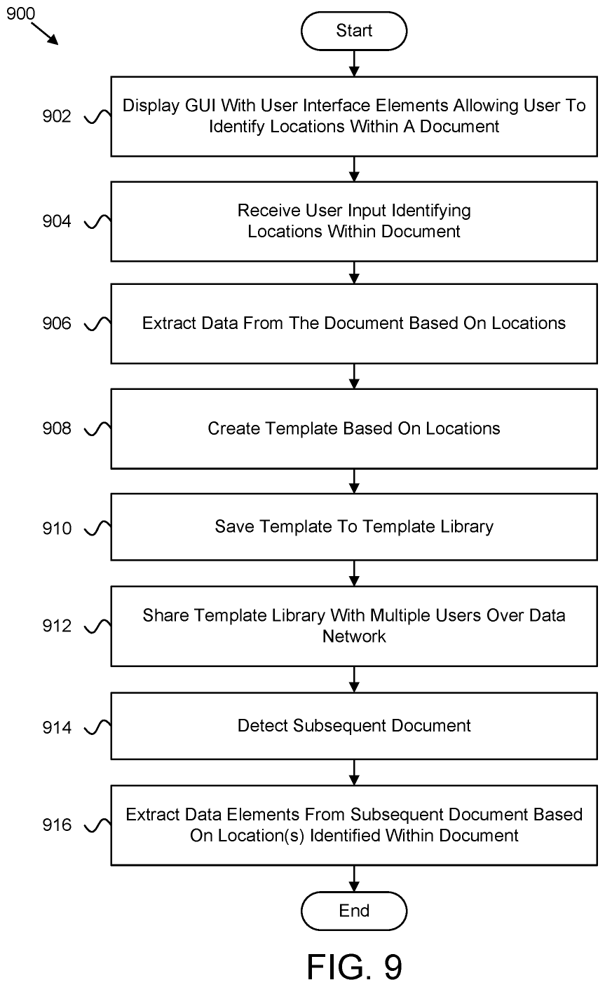

FIG. 9 depicts one embodiment of a method 900 for data location mapping and/or extraction. The method 900 begins, and the document management apparatus 104 displays 902 a graphical user interface 200, 300, 400, 500, 600, 700 to a user on an electronic display screen for a computing device 102, the graphical user interface 200, 300, 400, 500, 600, 700 comprising user interface elements 202a-n allowing the user to identify a plurality of locations within a first document 204.

The document management apparatus 104 receives 904 user input based on the user interacting with the user interface elements 202a-n of the graphical user interface 200, 300, 400, 500, 600, 700 to identify the plurality of locations within the first document 204. The document management apparatus 104 extracts 906 data from the first document 204 based on the plurality of locations identified within the first document 204.

The document management apparatus 104 creates 908 a template based on the plurality of locations identified within the first document 204. The document management apparatus 104 saves 910 the template to a template library comprising a plurality of templates for different types of documents with different identified locations. The document management apparatus 104 shares 912 the template library with multiple users over a data network 106 in different graphical user interfaces for extracting data from different documents.

The document management apparatus 104 detects 914 a subsequent document 204. The document management apparatus 104 extracts 916 data from the subsequent document 204 based on the plurality of locations identified within the first document 204 and the method 900 ends.

A means for displaying a graphical user interface 200, 300, 400, 500, 600, 700 comprising user interface elements 202a-n allowing a user to identify a plurality of locations within a first document 204, in various embodiments, may comprise one or more of a document management apparatus 104, an electronic display screen, a hardware computing device 102, a server 108, a graphics processing unit (GPU), a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for displaying a graphical user interface 200, 300, 400, 500, 600, 700 comprising user interface elements 202a-n allowing a user to identify a plurality of locations within a first document 204.

A means for receiving user input based on the user interacting with user interface elements 202a-n of a graphical user interface 200, 300, 400, 500, 600, 700 to identify a plurality of locations within a first document 204, in various embodiments, may comprise one or more of a document management apparatus 104, an electronic display screen, a touchscreen, a mouse, a keyboard, a touchpad, a microphone, a camera, a sensor, a user input device, a network interface, a data network 106, a hardware computing device 102, a server 108, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for receiving user input based on the user interacting with user interface elements 202a-n of a graphical user interface 200, 300, 400, 500, 600, 700 to identify a plurality of locations within a first document 204.

A means for detecting a subsequent document 204, in various embodiments, may comprise one or more of a document management apparatus 104, a camera, a scanner, a sensor, a network interface, a data network 106, a hardware computing device 102, a server 108, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for detecting a subsequent document 204.

A means for extracting data from a subsequent document 204 based on a plurality of locations identified within the first document 204, in various embodiments, may comprise one or more of a document management apparatus 104, a camera, a scanner, a sensor, a hardware computing device 102, a server 108, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for extracting data from a subsequent document 204 based on a plurality of locations identified within the first document 204.

A means for creating a template based on a plurality of locations identified within a first document 204, in various embodiments, may comprise one or more of a document management apparatus 104, a hardware computing device 102, a server 108, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for creating a template based on a plurality of locations identified within a first document 204.

A means for saving a template to a template library comprising a plurality of templates for different types of documents 204 with different identified locations, in various embodiments, may comprise one or more of a document management apparatus 104, a hardware computing device 102, a server 108, a non-volatile storage device, a volatile memory, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for saving a template to a template library comprising a plurality of templates for different types of documents 204 with different identified locations.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising program code stored on a non-transitory computer readable storage medium, the program code executable by a processor to perform operations, the operations comprising:
displaying a graphical user interface to a user on an electronic display screen for a computing device, the graphical user interface comprising user interface elements allowing the user to identify a plurality of locations within a first document;
receiving user input based on the user interacting with the user interface elements of the graphical user interface to identify the plurality of locations within the first document;
detecting a subsequent document; and
extracting data from the subsequent document based on the plurality of locations identified within the first document.

2. The computer program product of claim 1, the operations further comprising:
creating a template based on the plurality of locations identified within the first document; and
saving the template to a template library comprising a plurality of templates for different types of documents with different identified locations.

3. The computer program product of claim 2, the operations further comprising sharing the template library with multiple users over a data network in different graphical user interfaces for extracting data from different documents.

4. The computer program product of claim 2, the operations further comprising automatically matching the subsequent document to the created template in the template library, in response to detecting the subsequent document, based on the data extracted from the subsequent document.

5. The computer program product of claim 4, wherein the automatic matching is based on the data extracted from the subsequent document comprising one or more of a date, a string of text, a number, a monetary amount, an image, an identifier, and a filename matching the created template based on a probabilistic analysis.

6. The computer program product of claim 4, wherein the automatic matching is based on the data extracted from the subsequent document comprising a predefined override code associated with the created template.

7. The computer program product of claim 2, wherein the graphical user interface further comprises a list of processed documents, the list including both documents that have matched the plurality of templates of the template library and documents that have not matched the plurality of templates of the template library.

8. The computer program product of claim 7, wherein the graphical user interface displays one or more extracted data elements from the processed documents, and further comprises one or more user interface elements allowing the user to manually apply one or more of the plurality of templates of the template library to one or more of the documents that have not matched the plurality of templates of the template library.

9. The computer program product of claim 1, the operations further comprising extracting data from the first document based on the plurality of locations identified within the first document.

10. A method comprising:
displaying a graphical user interface to a user on an electronic display screen for a computing device, the graphical user interface comprising user interface elements allowing the user to identify a plurality of locations within a first document;
receiving user input based on the user interacting with the user interface elements of the graphical user interface to identify the plurality of locations within the first document;
detecting a subsequent document; and
extracting data from the subsequent document based on the plurality of locations identified within the first document.

11. The method of claim 10, further comprising:
creating a template based on the plurality of locations identified within the first document; and
saving the template to a template library comprising a plurality of templates for different types of documents with different identified locations.

12. The method of claim 11, further comprising sharing the template library with multiple users over a data network in different graphical user interfaces for extracting data from different documents.

13. The method of claim 11, further comprising automatically matching the subsequent document to the created template in the template library, in response to detecting the subsequent document, based on the data extracted from the subsequent document.

14. The method of claim 13, wherein the automatic matching is based on the data extracted from the subsequent document comprising one or more of a date, a string of text, a number, a monetary amount, an image, an identifier, and a filename matching the created template based on a probabilistic analysis.

15. The method of claim 13, wherein the automatic matching is based on the data extracted from the subsequent document comprising a predefined override code associated with the created template.

16. The method of claim 11, wherein the graphical user interface further comprises a list of processed documents, the list including both documents that have matched the plurality of templates of the template library and documents that have not matched the plurality of templates of the template library.

17. The method of claim 16, wherein the graphical user interface displays one or more extracted data elements from the processed documents, and further comprises one or more user interface elements allowing the user to manually apply one or more of the plurality of templates of the template library to one or more of the documents that have not matched the plurality of templates of the template library.

18. The method of claim 10, further comprising extracting data from the first document based on the plurality of locations identified within the first document.

19. An apparatus comprising:
means for displaying a graphical user interface to a user on an electronic display screen for a computing device, the graphical user interface comprising user interface elements allowing the user to identify a plurality of locations within a first document;
means for receiving user input based on the user interacting with the user interface elements of the graphical user interface to identify the plurality of locations within the first document;
means for detecting a subsequent document; and
means for extracting data from the subsequent document based on the plurality of locations identified within the first document.

20. The apparatus of claim 19, further comprising:
means for creating a template based on the plurality of locations identified within the first document; and
means for saving the template to a template library comprising a plurality of templates for different types of documents with different identified locations.
